(19) United States
(12) Patent Application Publication
(10) Pub. No.: US 2025/0354092 A1
(43) Pub. Date: Nov. 20, 2025

(54) CLEANING COMPOSITION AND METHOD FOR REMOVING POLYMER FILM BONDING MATERIALS USING THE SAME

(71) Applicant: Hongyue Advanced Technology Co., Ltd., Hsinchu City (TW)

(72) Inventor: Ying-Hao Li, Hsinchu City (TW)

(21) Appl. No.: 19/207,320

(22) Filed: May 13, 2025

(30) Foreign Application Priority Data
May 14, 2024 (TW) 113117752

(51) Int. Cl. C11D 7/06; B08B 3/10; C11D 7/50

(52) U.S. Cl. CPC C11D 7/06; B08B 3/10; C11D 7/5009; C11D 7/5013; C11D 7/5022

(57) ABSTRACT

The present disclosure relates to a cleaning composition and a method for removing residual polymer film bonding materials on a carrier after mechanical debonding or laser debonding using the same, wherein the cleaning composition at least includes component (A) alkali metal hydroxide (weight percentage concentration: 5%-30%), component (B) polar aprotic solvent (weight percentage concentration: 5%-50%), component (C) co-solvent (weight percentage concentration: 5%-60%) and component (D) water.

### BACKGROUND

### 1. Technical Field

The present disclosure relates to a cleaning composition and a method for removing residual polymer film bonding materials on a carrier by using the cleaning composition, especially to a cleaning composition and a method for removing bonding materials applied in a cleaning process of bonding materials during a packaging process.

2. Description of Associated Art

In response to the requirement for high performance, low cost and small size of electronic devices, a fan-out wafer-level packaging has been developed as an advanced packaging technique. The temporary bonding/debonding technique on which the advanced fan-out technique relies constitutes the foundation for manufacturing the devices.

The fan-out process is classified into two major categories: chip-first process and redistribution layer (RDL)-first process.

The chip-first process utilizes a wafer reconstruction process, in which known qualified wafers will be picked out from the original device wafers and placed on a substrate, and then molded into reconstructed wafers by resin encapsulation. Thereafter, the reconstructed wafer will be bonded to a carrier temporarily to flatten the inherent bow for forming the RDL on the wafer subsequently.

In an RDL-first process, the RDL layer will be established on the top of a support wafer and coated with a temporary bonding material layer, then a qualified wafer will be placed on the top of a known qualified RDL, and a molding and mold grinding process will be performed.

In both processes, a wafer will generally be subjected to metallization, photolithography imaging, dielectric deposition, electro-plating, and other assembling processes in which a support carrier is needed.

In the architectures of chip-first and RDL-first, several different changes, such as bonding with the grain surface upwards, bonding with the grain surface downwards, RDL thin line-first and RDL thick line-first, and the like, could increase the complexity and requirements for the carrier and equipment.

In the chip-first process, a wafer will exhibit severe bow due to the large inside stress after wafer thinning. Since a wafer will be subjected to an RDL formation process, during which materials on the wafer will be exposed to an environment at a high temperature reaching up to 250° C., and bonding lines will be exposed to various process chemicals including strong acids, strong bases, and solvents. For supporting the wafer throughout the process, bonding materials that are resistant to high temperature are needed. In the subsequent debonding of the wafer from the carrier, a method of mechanical debonding or laser debonding is utilized.

In a RDL-first process, the RDL for die adhesion and the assembly process are carried out on a temporary carrier and the carrier is coated with bonding materials thereon. Process steps are performed to establish a multi-layered RDL structure, and then the die adhesion, press grinding and mold grinding, as well as carrier debonding are performed. In a wafer level process, laser debonding is usually utilized as the commonly used method for debonding a wafer from a carrier in a RDL-first process.

A thinned wafer is prone to break during transport in the process due to its insufficient strength; and the thinned wafer exhibits severe bow due to the large stress inside. Therefore, it is necessary to fix a wafer with bonding materials on a carrier of glass, alumina, or silicon carbide prior to the wafer thinning to achieve temporary bonding of the carrier and the wafer, and then the subsequent process is performed.

Finally, the wafer must be debonded from the carrier. To debond the wafer from the carrier, methods of mechanical debonding and laser debonding are commonly used. Residual bonding materials on the carrier must be washed out completely, after which the carrier can be recycled.

In the current processes, after the mechanical debonding or laser debonding, the residual bonding materials on the carrier must be washed out by utilizing different cleaning agents depending on the separation method. The present disclosure provides a cleaning agent which can be used for cleaning and removing the residual polymer film bonding materials on a carrier after mechanical debonding or laser debonding.

In view of the various shortcomings and limitations in the application of known cleaning compositions, the present disclosure develop a cleaning composition and a method for removing polymer film bonding materials by using the cleaning composition.

### SUMMARY

The objective of the present disclosure is to provide a cleaning composition and a method for removing bonding materials by using the cleaning composition, the cleaning composition can effectively remove residual polymer film bonding materials on a carrier after mechanical debonding or laser debonding.

The present disclosure provides a cleaning composition for removing polymer film bonding materials, comprising: an alkali metal hydroxide; a polar aprotic solvent, a co-solvent; and water.

In one embodiment, based on the total weight of the cleaning composition, the alkali metal hydroxide has a weight percentage concentration of 5%-30%, the polar aprotic solvent has a weight percentage concentration of 5%-50%, the co-solvent has a weight percentage concentration of 5%-60%, and the remaining is water.

In one embodiment, based on the total weight of the cleaning composition, the alkali metal hydroxide has a weight percentage concentration of 10%-25%, the polar aprotic solvent has a weight percentage concentration of 15%-40%, the co-solvent has a weight percentage concentration of 15%-50%, and the remaining is water.

In one embodiment, the alkali metal hydroxide can comprise at least one selected from the group consisting of lithium hydroxide, sodium hydroxide, potassium hydroxide, rubidium hydroxide, and cesium hydroxide.

In one embodiment, the component (B) polar aprotic solvent has a relative dielectric constant (Erel) from greater than 15 and up to 180.

In one embodiment, the polar aprotic solvent comprises at least one selected from the group consisting of a sulfoxide solvent, a sulfone solvent, an amide solvent, a pyrrolidone solvent, and a lactone solvent.

In one embodiment, the sulfoxide solvent comprises at least one selected from the group consisting of dimethyl sulfoxide, diethyl sulfoxide, dipropyl sulfoxide, methyl ethyl sulfoxide, diphenyl sulfoxide, methyl phenyl sulfoxide, and 1,1′-bis(hydroxyphenyl) sulfoxide.

In one embodiment, the sulfone solvent comprises at least one selected from the group consisting of sulfolane, 3-methylsulfolane, and 2,4-dimethylsulfolane.

In one embodiment, the amide solvent comprises at least one selected from the group consisting of N,N-dimethylformamide, N,N-dimethylacetamide, N,N-dimethylpropanamide, N,N-dimethylbutyramide, N,N-dimethylisobutyramide, N,N-diethylformamide, N,N-diethylacetamide, N,N-diethylpropanamide, N,N-diethylbutyramide, N,N-diethylisobutyramide, N,N-dipropylacetamide, hexamethylphosphamide, N-methylformamide, N-methylacetamide, N-methylpropanamide, N-methyl-N-ethylpropanamide, N-ethyl-N-methylpropanamide, N-ethyl-N-methylbutyramide, N-ethyl-N-methylisobutyramide, formamide, and acetamide.

In one embodiment, the pyrrolidone solvent has a C1-C8 alkyl group attached to the N atom thereof. For example, the pyrrolidone solvent comprises at least one selected from the group consisting of N-methyl-2-pyrrolidone, N-ethylpyrrolidone, N-isopropylpyrrolidone, N-butyl-2-pyrrolidone, N-hydroxyethyl-2-pyrrolidone, and N-hydroxypropyl-pyrrolidone.

In one embodiment, the lactone solvent comprises at least one selected from the group consisting of β-propiolactone, γ-butyrolactone, and δ-valerolactone.

In one embodiment, the co-solvent can comprise an alcohol solvent or an amine solvent.

In one embodiment, the co-solvent is a polyol solvent.

In one embodiment, the alcohol solvent can comprise at least one selected from the group consisting of ethylene glycol, propylene glycol, dipropylene glycol, glycerol, benzyl alcohol, tetrahydrofurfuryl alcohol, 2-methoxyethanol, phenoxyethanol, and 3-methoxy-3-methylbutanol.

In one embodiment, the amine solvent can comprise at least one selected from the group consisting of monoethanolamine, triethanolamine, isopropanolamine, 2-(2-aminoethoxy) ethanol, and 2-amino-2-methyl-1-propanol.

The present disclosure further provides a removing method of bonding materials, comprising: providing the cleaning composition of the present disclosure; heating the cleaning composition; and contacting the cleaning composition with residual polymer film bonding materials on a carrier to remove the polymer film bonding materials.

In one embodiment, the removing method is performed by contacting the cleaning composition with the residual polymer film bonding materials on the carrier by utilizing a manner of soaking, dipping, coating, spin-coating, spraying, or rinsing.

In one embodiment, the cleaning composition is heated at a temperature ranging from 20° C. to 90° C.

The cleaning composition of the present disclosure can completely remove residual bonding materials on a carrier after laser debonding or mechanical debonding. And no abnormal surface appearance of the carrier occurs after removing the residual bonding materials from the carrier. The efficacy of the present disclosure is not achievable by using an individual component or in combination with other components.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present disclosure can be more fully understood by reference to the following descriptions of the embodiments in conjunction with the accompanying drawings.

FIG. 1-1 shows the residual acrylic bonding materials on a glass carrier after laser debonding.

FIG. 1-2 shows Comparative Example 2, in which residual acrylic bonding materials on the glass carrier after laser debonding is washed with a cleaning agent, and the acrylic bonding materials still remained on the glass carrier.

FIG. 1-3 shows Example 12, in which residual acrylic bonding materials on the glass carrier after laser debonding is washed with a cleaning agent to remove the acrylic bonding materials, and there is no acrylic bonding material residue on the glass carrier.

FIG. 2-1 shows the residual silicone bonding materials on a glass carrier after laser debonding.

FIG. 2-2 shows Comparative Example 1, in which residual silicone bonding materials on the glass carrier after laser debonding is washed with a cleaning agent, and the silicone bonding materials still remained on the glass carrier.

FIG. 2-3 shows Example 19, in which residual silicone bonding materials on the glass carrier after laser debonding is washed with a cleaning agent to remove the silicone bonding materials, and there is no silicone bonding material on the glass carrier.

FIG. 3-1 shows the residual silicone bonding materials on an alumina carrier after mechanical debonding.

FIG. 3-2 shows Example 19, in which residual silicone bonding materials on the alumina carrier after mechanical debonding is washed with a cleaning agent to remove the silicone bonding materials, and there is no silicone bonding material on the alumina carrier.

FIG. 4-1 shows the residual polyimide bonding materials on a silicon carbide carrier after laser debonding.

FIG. 4-2 shows Example 11, in which residual polyimide bonding materials on the silicon carbide carrier after laser debonding is washed with a cleaning agent to remove the polyimide bonding materials, and there is no polyimide bonding material on the silicon carbide carrier.

### DETAILED DESCRIPTION OF THE PREFERRED EMBODIMENTS

The execution modes of the present disclosure will be illustrated by following specific embodiments, one skilled in the art can easily realize the advantages and effects of the present disclosure based on the content described in the description, and thus completing the invention of the present disclosure. The present invention also can be performed or applied by other different execution modes, and the details of the present invention each can be imparted with different modifications and alternations based on different views and applications without departing from the scope described by the present disclosure. It should be appreciated that the following examples are provided for illustration of the content of the present disclosure rather than limitation of the scope of the present disclosure.

It should be appreciated that in the present specification, any change of the proportion relationship, or adjustment of the size, without affecting the efficacy and purpose of the present disclosure, should fall in the scope of the technical content disclosed in the present disclosure. Furthermore, all ranges and values recited in the present invention are inclusive and combinable. Any value or point falling in the ranges recited herein, such as any integers, can be used as the lower or upper limit to derive a subrange.

When expressed as “comprise” components or steps herein, other components or other steps can further included rather than excluded, unless stated otherwise. As used herein, a singular form “a”, “an” and “the” includes a singular form and a plural form, unless indicated otherwise clearly in the context. The term “and/or” is used as an abbreviation for “and” stating a combination of objects and “or” stating alternative objects. The term “or” is used with its meaning including “and/or”, unless indicated otherwise clearly in the context.

As stated above, the present disclosure relates to a cleaning composition, which comprises, essentially consists of, or consists of the components: (A) alkali metal hydroxide; (B) polar aprotic solvent; (C) co-solvent; and (D) water.

A base is a compound that is basic after being dissolved in water, the aqueous solution of which has a pH value greater than 7 at room temperature, and generally refers to hydroxides and oxides of alkali metals and alkaline earth metals. The basic compounds are broadly used in cleaning agents, photo resist removers, debonders, surface treatment agents, and other compositions. The present disclosure selects component (A) alkali metal hydroxide since an alkali metal hydroxide has a higher solubility than that of an alkaline earth metal hydroxide. The component (A) alkali metal hydroxide has a high dissolving capability for bonding materials, and can be used to effectively remove residual bonding materials, such as polymer films, on the carrier during the process.

In one embodiment, the component (A) alkali metal hydroxide can comprise at least one selected from the group consisting of lithium hydroxide, sodium hydroxide, potassium hydroxide, rubidium hydroxide, and cesium hydroxide, but is not limited thereto. In one embodiment, regarding to the ability to its solubility in forming a solution, its stability in the solution, and the ability to clean residual without metal residues, the component (A) alkali metal hydroxide is preferably potassium hydroxide, sodium hydroxide, and a combination thereof.

In one embodiment, the component (A) alkali metal hydroxide has a weight percentage concentration ranging from 5% to 30%. Specifically, the component (A) alkali metal hydroxide can have a weight percentage concentration of 5, 6, 7, 8, 9, 10, 11, 12, 13, 14, 15, 16, 17, 18, 19, 20, 21, 22, 23, 24, 25, 26, 27, 28, 29, or 30%. In one embodiment, the component (A) alkali metal hydroxide has a weight percentage concentration ranging from 10% to 25%.

The polar aprotic solvent is a solvent which itself has no easily-dissociable H+or acidic hydrogen, does not exhibit hydrogen-bonding, is capable of stabilizing ions, and has high dissolving capability. It has a high dielectric constant and molecular polarity, with a negatively charged terminus exposed outside and a positively charged terminus masked inside, and can solvate cations, especially metal cations. The dielectric constant is an important property of a solvent, and represents the ability of the solvent to solvate solute molecules and to separate ions. The solvent with a higher dielectric constant has a higher ability to separate ions and a stronger ability to solvate. In general, a relative dielectric constant value less than 15 is non-polar, and a relative dielectric constant greater than 15 is polar. Examples of the relative dielectric constant values of the polar aprotic solvents of the present disclosure are listed in the Table below.

| | Relative dielectric |
|---|---|
| Solvent | constant (εᵣₑₗ) |
| Dimethyl sulfoxide | 46.68 |
| Sulfolane | 44 |
| N,N-dimethylformamide | 36.71 |
| N,N-dimethylacetamide | 37.78 |
| N,N-dimethylpropanamide | 33.08 |
| N,N-diethylformamide | 29.02 |
| N,N-diethylacetamide | 31.33 |
| Hexamethylphosphamide | 30 |
| N-methylformamide | 171 |
| N-methylacetamide | 178.9 |
| Formamide | 111 |
| Acetamide | 67.6 |
| N-methyl-2-pyrrolidone | 32.2 |
| γ-Butyrolactone | 40.96 |

A polar aprotic solvent is suitable for reactions in which a strong base is involved, as compared to a protic solvent. As used herein, the component (B) polar aprotic solvent is used with component (A) alkali metal hydroxide to dissolve a polymer film. In one embodiment, the component (B) polar aprotic solvent has a relative dielectric constant (Erel) greater than 15 and up to 180, e.g., 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, or 180.

In one embodiment, the component (B) polar aprotic solvent comprises at least one selected from the group consisting of a sulfoxide solvent, a sulfone solvent, an amide solvent, a pyrrolidone solvent, and a lactone solvent.

In one embodiment, the sulfoxide solvent comprises at least one selected from the group consisting of dimethyl sulfoxide, diethyl sulfoxide, dipropyl sulfoxide, methyl ethyl sulfoxide, diphenyl sulfoxide, methyl phenyl sulfoxide, and 1,1′-bis(hydroxyphenyl) sulfoxide.

In one embodiment, the sulfone solvent comprises at least one selected from the group consisting of sulfolane, 3-methylsulfolane, and 2,4-dimethylsulfolane.

In one embodiment, the amide solvent comprises at least one selected from the group consisting of N,N-dimethylformamide, N,N-dimethylacetamide, N,N-dimethylpropanamide, N,N-dimethylbutyramide, N,N-dimethylisobutyramide, N,N-diethylformamide, N,N-diethylacetamide, N,N-diethylpropanamide, N,N-diethylbutyramide, N,N-diethylisobutyramide, N,N-dipropylacetamide, hexamethylphosphamide, N-methylformamide, N-methylacetamide, N-methylpropanamide, N-methyl-N-ethylpropanamide, N-ethyl-N-methylpropanamide, N-ethyl-N-methylbutyramide, N-ethyl-N-methylisobutyramide, formamide, and acetamide.

In one embodiment, the pyrrolidone solvent has a C1-C8 alkyl group attached to the N atom thereof, for example, N-methyl-2-pyrrolidone, N-ethylpyrrolidone, N-propyl-2-pyrrolidone, N-isopropylpyrrolidone, and N-butyl-2-pyrrolidone. In another embodiment, examples of the pyrrolidone solvent include N-hydroxyethyl-2-pyrrolidone or N-hydroxypropyl-pyrrolidone, but are not limited thereto.

In one embodiment, the lactone solvent comprises at least one selected from the group consisting of β-propiolactone, γ-butyrolactone, and δ-valerolactone.

In one embodiment, the component (B) polar aprotic solvent has a weight percentage concentration ranging from 5% to 50%. Specifically, the component (B) polar aprotic solvent can have a weight percentage concentration of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50%. In one embodiment, the component (B) polar aprotic solvent has a weight percentage concentration ranging from 15% to 40%.

In general, a co-solvent is an organic solvent and can enhance the dissolving capacity of the main solvent in the solution. As used herein, the component (C) co-solvent is helpful for solvation of the alkali metal hydroxide in a polar aprotic solvent, improves the solubility of the alkali metal hydroxide in the solution, and reduces precipitation of the base from the solution.

In one embodiment, the component (C) co-solvent can include an alcohol solvent, an amine solvent, and the like.

The alcohol solvent can include a monobasic alcohol, such as methanol, ethanol, n-propanol, isopropanol, n-butanol, isobutanol, sec-butanol, t-butanol, 2-methylbutanol, 2-ethylbutanol, n-pentanol, isopentanol, sec-pentanol, t-pentanol, 2-methylpentanol, 3-methyl-3-pentanol, n-hexanol, sec-hexanol, 2-ethylhexanol, sec-heptanol, 3-heptanol, n-octanol, sec-octanol, n-nonanol, 2,6-dimethyl-4-heptanol, n-decanol, 1-undecanol, sec-undecanol, trimethylnonanol, allyl alcohol, propargyl alcohol, 2-butenol, 3-butenol, 4-penten-2-ol, phenol, cyclohexanol, methylcyclohexanol, benzyl alcohol, diacetone alcohol, cresol, and a mixture thereof, etc., but is not limited thereto.

The alcohol solvent can also comprise an ether alcohol, such as: ethylene glycol methyl ether, ethylene glycol dimethyl ether, ethylene glycol diethyl ether, diethylene glycol methyl ether, diethylene glycol ethyl ether, diethylene glycol propyl ether, diethylene glycol butyl ether, diethylene glycol dibutyl ether, propylene glycol methyl ether, dipyropylene glycol methyl ether, propylene glycol ethyl ether, dipyropylene glycol ethyl ether, propylene glycol propyl ether, propylene glycol butyl ether, dipyropylene glycol propyl ether, propylene glycol phenyl ether, propylene glycol n-butyl ether, dipyropylene glycol n-butyl ether, ethylene glycol ethyl ether, ethylene glycol n-propyl ether, ethylene glycol isopropyl ether, ethylene glycol butyl ether, ethylene glycol phenyl ether, tripropylene glycol methyl ether, tripropylene glycol ethyl ether, dipropylene glycol dimethyl ether, diethylene glocyl methyl ethyl ether, diethylene glycol dimethyl ether, diethylene glycol diethyl ether, triethylene glycol methyl ether, triethylene glycol dimethyl ether, triethylene glycol ethyl ether, triethylene glycol diethyl ether, triethylene glycol propyl ether, triethylene glycol butyl ether, ethylene glycol benzyl ether, diethylene glycol benzyl ether, diethylene glycol methyl ethyl ether, 2-methoxyethanol, 2-methoxypropanol, 3-methoxybutanol, 3-methoxy-3-methylbutanol, 1-methoxy-2-propanol, 2-ethoxy-ethanol, 2-ethoxy-1-propanol, 1-ethoxy-2-propanol, 2-isopropoxy-ethanol, 1-butoxy-2-propanol, 1-methoxy-2-butanol, phenoxyethanol, 2-benzyloxyethanol, 3-phenoxybenzyl alcohol, furfuryl alcohol, tetrahydrofurfuryl alcohol, and a mixture thereof, but is not limited thereto.

The alcohol solvent can further include a polyol solvent, for example, a polyol, such as: ethylene glycol, propylene glycol, butanediol, pentanediol, cyclopentanediol, hexanediol, cyclohexanediol, heptanediol, 2-methyl-1,3-propylene glycol, 2,2-dimethyl-1,3-propylene glycol, 2-butyl-2-ethyl-1,3-propanediol, 2-ethyl-2-isobutyl-1,3-propanediol, 2-methyl-2,4-pentanediol, 2,2,4-trimethyl-1,3-pentanediol, 2-ethyl-1,3-hexanediol, 2,2,4,4-tetramethyl-1,6-hexanediol, diethylene glycol, dipyropylene glycol, triethylene glycol, tripropylene glycol, tetraethylene glycol, glycerol, butanetriol, pentanetriol, and a mixture thereof, etc., but is not limited thereto.

The amine solvent can include an alkanolamine, such as: monoethanolamine, N-methylethanolamine, N-ethylethanolamine, N-propylethanolamine, N-butylethanolamine, dimethylethanolamine, diethylethanolamine, diethanolamine, triethanolamine, N-methyldiethanolamine, N-ethyldiethanolamine, isopropanolamine, diisopropanolamine, triisopropanolamine, N-methylisopropanolamine, N-ethylisopropanolamine, N-propylisopropanolamine, 2-amino-1-propanol, N-methyl-2-amino-1-propanol, N-ethyl-2-amino-1-propanol, 1-amino-3-propanol, N-methyl-1-amino-3-propanol, N-ethyl-1-amino-3-propanol, 1-amino-2-butanol, N-methyl-1-amino-2-butanol, N-ethyl-1-amino-2-butanol, 2-amino-1-butanol, N-methyl-2-amino-1-butanol, N-ethyl-2-amino-1-butanol, 3-amino-1-butanol, N-methyl-3-amino-1-butanol, N-ethyl-3-amino-1-butanol, 1-amino-4-butanol, N-methyl-1-amino-4-butanol, N-ethyl-1-amino-4-butanol, 1-amino-2-methyl-2-propanol, 1-amino-2-methyl-2-pentanol, 2-amino-2-methyl-1-propanol, 1-amino-4-pentanol, 2-amino-4-methyl-1-pentanol, 2-amino-1-hexanol, 3-amino-4-heptanol, 1-amino-2-octanol, 5-amino-4-octanol, 1-amino-2,3-propylene glycol, 2-amino-1,3-propylene glycol, tri (oxymethyl) aminomethane, 1,2-diamino-3-propanol, 1,3-diamino-2-propanol, 2-(2-aminoethoxy) ethanol, 4-(2-hydroxyethyl) morpholine, 1-(2-hydroxyethyl) piperidine, 1-(2-hydroxyethyl) piperazine, aminoethylethanolamine, ether of alkanolamine, and a mixture thereof, but is not limited thereto.

In one embodiment, the component (C) co-solvent has a weight percentage concentration between 5% to 60%. Specifically, the component (C) co-solvent can have a weight percentage concentration of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60%. In one embodiment, the component (C) co-solvent has a weight percentage concentration ranging from 15% to 50%.

In addition to the component (A) alkali metal hydroxide, the component (B) polar aprotic solvent and the component (C) co-solvent, the remaining component of the cleaning composition is (D) water. Water, such as ion-exchanged water, reverse osmosis water, distilled water, refined water, purified water, and pure water, etc. can be used, but not limited thereto.

In addition to the components (A)-(D), the cleaning composition of the present disclosure can optionally further contain other components as long as the objective of the present disclosure is not interfered with. Examples of other components are the components generally used in a cleaning composition, including but not limited to: a base solvent other than the component (A), a solvent other than the components (B) and (C), other additives such as corrosion inhibitor, oxidant, cross-linking agent, deterioration inhibitor, interface modifier, surfactant, anti-foamer, chelating agent, viscosity enhancing agent, dispersing agent, anti-rusting agent, anti-oxidizing agent, anti-bacterial agent, anti-mold agent, polymerization resisting agent, electro-conductivity aid, and the like.

Terms “cleaning”, “removing”, “debonding” used interchangeably herein mean a method for removing, peeling off, or washing out bonding materials from a carrier by using the cleaning composition of the present disclosure.

The present disclosure provides a method for removing residual polymer film bonding materials on a carrier after mechanical debonding or laser debonding by using the cleaning composition of the present disclosure, comprising: formulating the cleaning composition of the present disclosure to provide the cleaning composition of the present disclosure; heating the cleaning composition; and contacting the cleaning composition with residual polymer film bonding materials on carrier in a manner of soaking or spraying, to remove the residual polymer film bonding materials on the carrier after laser debonding or mechanical debonding.

Specifically, the components (A) alkali metal hydroxide, (B) polar aprotic solvent, (C) co-solvent, and (D) are mixed at a particular ratio to formulate a cleaning composition. Their mixing order has no particular limitation, and the components described above can be mixed simultaneously or in any order. That is, all components can be mixed collectively; or a portion of the components can be mixed first, and then mixed with the remaining components further. Optionally, the solvent or solution used can also be filtered with a filter, to remove impurities. In the formulating method of the cleaning composition of the present disclosure, the specific proportion of each component can be set to be the same as the preferred content of each component in the cleaning composition of the present disclosure described above.

After formulation of the cleaning composition, the cleaning composition is heated to a set temperature. The set temperature can be adjusted depending on the kinds and amounts of the components contained in the cleaning composition, and the boiling point of the solvent used. The set temperature can be between 20° C. to 90° C. Specifically, the set temperature can be 20° C., 25° C., 30° C., 35° C., 40° C., 45° C., 50° C., 55° C., 60° C., 65° C., 70° C., 75° C., 80° C., 85° C., or 90° C., but is not limited thereto. In one embodiment, the set temperature is between 40° C. to 80° C. The heating can be performed with a heat plate, a heater, an oven, or a hot bath, and the like.

After heating the cleaning composition to the set temperature, the cleaning composition is allowed to contact the surface of the carrier after laser debonding or mechanical debonding. The manner for performing the contacting has no particular limitation, and can utilize soaking, dipping, coating, spin coating, spraying, or rinsing methods, and the like, to contact the cleaning composition with residual polymer film bonding materials on the carrier.

The period for the cleaning composition of the present disclosure contacting the carrier (e.g., soaking duration) has no particular limitation, as long as the residual bonding materials on the carrier can be effectively removed, and the carrier can be removed periodically for observing the cleaning and residue levels. The period for contacting can be 5 minutes, 10 minutes, 15 minutes, 20 minutes, 25 minutes, 30 minutes, 35 minutes, 40 minutes, 45 minutes, 50 minutes, 55 minutes, 60 minutes, 65 minutes, 70 minutes, etc., but is not limited thereto. In one embodiment, the period for contacting can be 5-70 minutes.

The carrier, for which the cleaning composition of the present disclosure is suitable, covers a broad range and can be made of a metal oxide (such as an oxide of copper, aluminum, nickel, zinc, iron, chromium, an alloy thereof, and the like), glass, quartz, silicon carbide, silicon, gallium arsenide, indium phosphide, an organic material, ceramic, prepreg, dielectrics, resin, solder resist materials, etc., but is not limited thereto.

The laser debonding is a process for separating a wafer from a carrier through laser. The laser debonding provides a low stress separating and transmission of high energy light. Generally, such a process uses a laser band of 300-400 nm to destroy a polymer. The bonding materials absorb the laser light at a respective wavelength and convert it into heat energy to generate a high temperature at the bonding interface, or destroy chemical bonds by using the energy from the laser light to decompose the bonding materials in an intermediate medium layer, thereby losing function. The decomposition products include gas, which increase the pressure at the bonding interface, thereby achieving debonding. The use of laser debonding with bonding materials requires that the respective laser reacts with them, and that the carrier used should be transmissive to the laser, e.g., glass.

The mechanical debonding is a process for separating a wafer from a carrier in a mechanical manner after forming a cut between them, relying on a mechanical stress. During mechanical debonding, a crack is firstly generated between the wafer and the carrier, a debonding blade is inserted at the side of the carrier to fix it horizontally with the wafer downwards, and a stress upwards is applied on the carrier at the upper side after insertion of the blade to allow the crack described above to proceed, thereby debonding the wafer/carrier. The mechanical debonding needs a weak adhesion force between the bonding materials and the wafer to achieve the debonding successfully.

The polymer film bonding materials of the present disclosure are materials used in a wafer processing process for fixing the manufactured wafer with a carrier temporarily for subsequent processing, testing, and packaging processes, and these materials can be removed in subsequent process steps. Many of the bonding materials are polymer materials, which can be cured rapidly at a high temperature to form a strong adhesion layer (polymer film), adhering the wafer and the carrier tightly. Due to the viscosity of the bonding materials and the action of surface tension, some contacting area can be generated between the wafer and the carrier to achieve stable adhesion.

The bonding materials can include various materials providing adhesion capability, such as resin, polymer, polymer composite, polymer with fillers, organic polymer film, epoxy resin, epoxy resin with fillers, epoxy acrylic with fillers, silicone, silicon resin, phenolic resin, acrylic resin, cycloolefin polymer, polyester, polyimide, polycarbonate, polyurethane, polyether, polyetherimide, fluorocarbon polymer, natural rubber or synthetic rubber, polyurethane acrylate, epoxy acrylate, polyester acrylate, and a combination thereof, and the like. Specifically, examples of the bonding materials can include polymethyl methacrylate, polyethylene terephthalate, glass frit, polybenzoxazole, phenylcyclobutene, bismaleimide-triazine, and a combination thereof, etc., but are not limited thereto.

The residual bonding materials are calculated in a weight percentage as: (weight of the carrier having residual bonding materials thereon after removal of the bonding materials-weight of the carrier)+ (weight of the carrier having residual bonding materials thereon before removal of the bonding materials-weight of the carrier)=residual bonding materials (%). In one embodiment, the carrier treated with the cleaning composition has residual bonding materials of less than 25%. In one embodiment, the carrier treated with the cleaning composition has residual bonding materials of less than 20%. In one embodiment, the carrier treated with the cleaning composition has residual bonding materials of less than 15%. In one embodiment, the carrier treated with the cleaning composition has residual bonding materials of less than 10%. In one embodiment, the carrier treated with the cleaning composition has residual bonding materials of less than 5%.

The cleaning compositions in Examples 1-20 and Comparative Examples 1-3 were prepared according to the proportions of components recorded in Table 1 and Table 2. The components in Table 1 and Table 2 were each prepared and mixed, heated to a set temperature, and cleaning for the residual polymer film bonding materials on the carrier after mechanical debonding and laser debonding, respectively. Weight of the carrier was weighed before and after cleaning, and the abilities of the cleaning compositions in Examples 1-20 and Comparative Example 1-3 to remove bonding materials by the residual bonding materials data.

Table 1 shows the components of each cleaning composition used in Examples 1 to 20, the contacting period for the cleaning composition contacting the carrier, the set temperature, the components of the bonding materials, and the results of the residual bonding materials. The contents (all in weight percentage concentration) of components (A) alkali metal hydroxide, (B) polar aprotic solvent, and (C) co-solvent contained in each composition are shown in Table 1. As described above, the component in addition to (A) alkali metal hydroxide, (B) polar aprotic solvent, and (C) co-solvent was water. In the Table, the column “residual bonding materials (%)” was calculated through the method described above and expressed also in weight percentage concentration.

TABLE 1
Examples

| | | | | | | | Residual bonding | |
|---|---|---|---|---|---|---|---|---|
| | | | Components of the cleaning composition | | | | materials | |
| | | | Weight percentage concentration (%) | | | | (%) | |
| | Temperature | Time | Alkali metal | Polar aprotic | | Bonding | Mechanical | Laser |
| Ex/ | (° C.) | (min) | hydroxide | solvent | Co-solvent | materials | debonding | debonding |
| 1 | 20 | 20 | Sodium | Sulfolane | 2- | Acrylic | 21.3 | 5.5 |
| | | | hydroxide | 50 | Methoxyethanol | | | |
| | | | 15 | | 5 | | | |
| 2 | 55 | 20 | Sodium | N,N- | 3-Methoxy-3- | Acrylic | 19.2 | 2.1 |
| | | | hydroxide | dimethylpropanamide | methylbutanol | | | |
| | | | 5 | 5 | 60 | | | |
| 3 | 40 | 30 | Potassium | N-Butylpyrrolidone | Tetrahydrofurfuryl | Silicone | 0 | 0 |
| | | | hydroxide | 15 | alcohol | | | |
| | | | 15 | | 50 | | | |
| 4 | 80 | 20 | Sodium | N,N- | Propylene | Acrylic | 0 | 0 |
| | | | hydroxide | dimethylacetamide | glycol | | | |
| | | | 10 | 40 | 20 | | | |
| 5 | 70 | 30 | Potassium | N-methylpyrrolidone | Tetrahydrofurfuryl | Silicone | 0 | 0 |
| | | | hydroxide | 30 | alcohol | | | |
| | | | 10 | | 40 | | | |
| 6 | 70 | 15 | Potassium | N-ethylpyrrolidone | Monoethanolamine | Silicone | 0 | 0 |
| | | | hydroxide | 25 | 25 | | | |
| | | | 15 | | | | | |
| 7 | 80 | 60 | Potassium | N- | Phenoxyethanol | Polyimide | 0 | 0 |
| | | | hydroxide | isopropylpyrrolidone | 15 | | | |
| | | | 10 | 30 | | | | |
| 8 | 90 | 25 | Potassium | γ-Butyrolactone | Tetrahydrofurfuryl | Acrylic | 21.1 | 0 |
| | | | hydroxide | 25 | alcohol | | | |
| | | | 30 | | 5 | | | |
| 9 | 80 | 30 | Sodium | N-ethylpyrrolidone | Propylene | Polyimide | 0 | 0 |
| | | | hydroxide | 30 | glycol | | | |
| | | | 15 | | 20 | | | |
| 10 | 80 | 60 | Potassium | N-ethylpyrrolidone | Tetrahydrofurfuryl | Silicone | 0 | 0 |
| | | | hydroxide | 35 | alcohol | | | |
| | | | 10 | | 40 | | | |
| 11 | 70 | 20 | Potassium | N-ethylpyrrolidone | Glycerol | Polyimide | 0 | 0 |
| | | | hydroxide | 25 | 25 | | | |
| | | | 18 | | | | | |
| 12 | 70 | 20 | Sodium | N,N-diethylformamide | Ethylene glycol | Acrylic | 0 | 0 |
| | | | hydroxide | 25 | 15 | | | |
| | | | 25 | | | | | |
| 13 | 30 | 15 | Sodium | γ-Butyrolactone | Dipropylene | Polyimide | 15.7 | 0 |
| | | | hydroxide | 40 | glycol | | | |
| | | | 20 | | 10 | | | |
| 14 | 80 | 35 | Sodium | N-ethyl-2-pyrrolidone | Triethanolamine | Acrylic | 5.8 | 0 |
| | | | hydroxide | 20 | 10 | | | |
| | | | 30 | | | | | |
| 15 | 65 | 40 | Potassium | N-ethyl-2-pyrrolidone | Benzyl alcohol | Acrylic | 0 | 0 |
| | | | hydroxide | 20 | 20 | | | |
| | | | 20 | | | | | |
| 16 | 55 | 10 | Potassium | N-methyl-2- | Monoethanolamine | Silicone | 12.1 | 0 |
| | | | hydroxide | pyrrolidone | 40 | | | |
| | | | 5 | 40 | | | | |
| 17 | 50 | 10 | Potassium | Dimethyl sulfoxide | Ethylene glycol | Acrylic | 18.9 | 0 |
| | | | hydroxide | 20 | 50 | | | |
| | | | 10 | | | | | |
| 18 | 80 | 60 | Potassium | N-methyl-2- | 2-(2- | Polyimide | 0 | 0 |
| | | | hydroxide | pyrrolidone | aminoethoxy)ethanol | | | |
| | | | 10 | 20 | 40 | | | |
| 19 | 75 | 30 | Potassium | N-ethyl-2-pyrrolidone | 2-amino-2- | Silicone | 0 | 0 |
| | | | hydroxide | 25 | methyl-1- | | | |
| | | | 15 | | propanol | | | |
| | | | | | 20 | | | |
| 20 | 70 | 35 | Potassium | N-methyl-2- | Isopropanolamine | Polyimide | 0 | 0 |
| | | | hydroxide | pyrrolidone | 15 | | | |
| | | | 15 | 30 | | | | |

Table 2 shows the components of each cleaning composition used in Comparative Examples 1 to 3, the contacting period for the cleaning composition contacting the carrier, the set temperature, the components of the bonding materials, and the results of the residual bonding materials. The contents (all in weight percentage concentration) of components (A) base solvent and (B) polar solvent contained in each composition are shown in Table 2. The component in addition to (A) base solvent and (B) polar solvent was water. In the Table, the column “residual bonding materials (%)” was calculated through the method described above and expressed also in weight percentage concentration.

TABLE 2
Comparative Examples

| | | | | | | Residual bonding | |
|---|---|---|---|---|---|---|---|
| | | | Components of the cleaning | | | materials | |
| | | | composition | | | (%) | |
| Comp. | Temperature | Time | Weight percentage concentration (%) | | Bonding | Mechanical | Laser |
| Ex. | (° C.) | (min) | Base solvent | Polar solvent | materials | debonding | debonding |
| 1 | 60 | 60 | Potassium hydroxide | | Silicone | 100 | 88.3 |
| | | | 25 | | | | |
| 2 | 70 | 60 | Tetramethylammonium | Dimethyl | Acrylic | 0 | 32.2 |
| | | | hydroxide | sulfoxide | | | |
| | | | 2.5 | 90 | | | |
| 3 | 70 | 60 | N-methyl-2- | | Polyimide | 100 | 93.2 |
| | | | pyrrolidone | | | | |
| | | | 100 | | | | |

The results of residual bonding materials in Table 1 demonstrate that the cleaning compositions of the present disclosure, which comprise component (A) alkali metal hydroxide, (B) polar aprotic solvent, and (C) co-solvent, have good abilities to remove bonding materials. Compared to the results of residual bonding materials in Table 2, all of the cleaning compositions of the present disclosure having components in different proportions could reduce acrylic, polyimide, and silicone residual bonding materials to below 25%, with the cleaning effects being significantly higher than the cleaning agent having a single main solvent component in the Comparative Examples. Particularly in examples at a preferred set temperature between 40° C. to 80° C., the effects of complete removal of residual bonding materials (0% residual bonding materials) were achieved on the carrier after laser debonding or mechanical debonding.

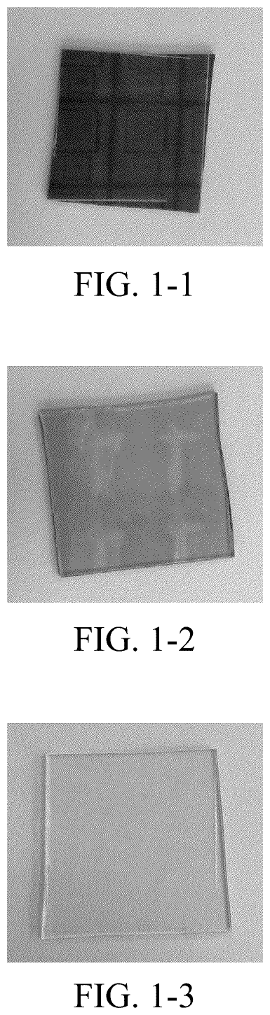

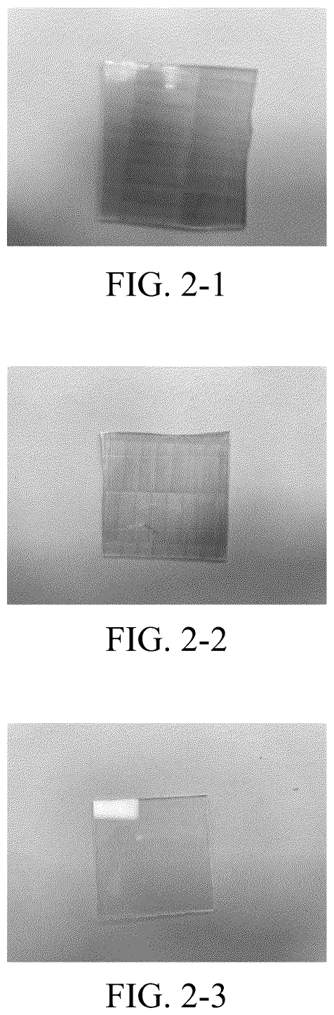

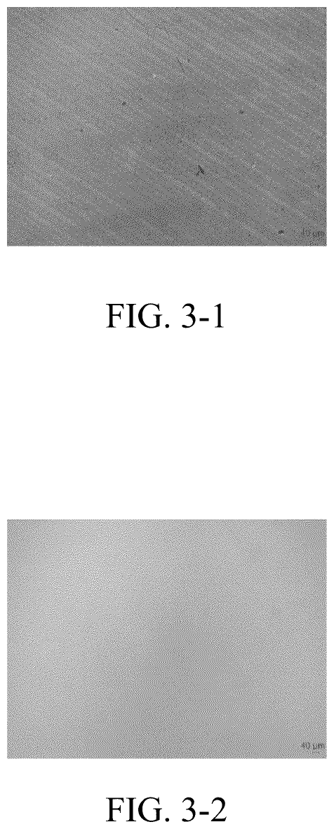

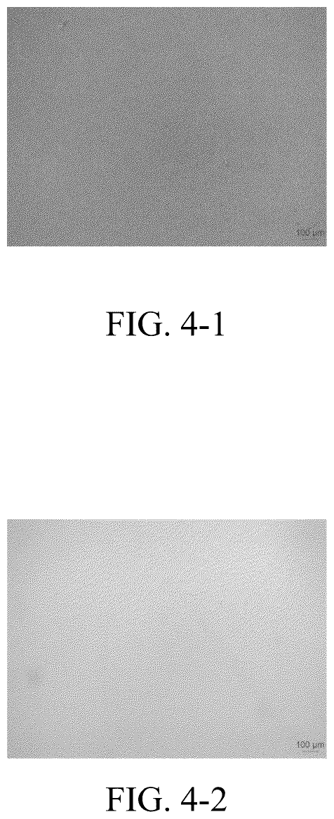

Also, as also shown in FIG. 1-1 to FIG. 4-2, there still were obviously residual bonding materials on the carrier treated with the cleaning agents in Comparative Examples, while there was no residue on the carrier cleaned in Examples, demonstrating that the cleaning compositions of the present disclosure have excellent cleaning effects. Residual bonding materials on the carrier could be completely removed by performing the cleaning on different carrier materials, including glass, alumina, and silicon carbide. And, the cleaning composition of the present disclosure did not cause any change in the appearance of the carrier while achieving good cleaning effects.

What is claimed is:

1. A cleaning composition for removing polymer film bonding materials, comprising:
an alkali metal hydroxide;
a polar aprotic solvent;
a co-solvent; and
water.

2. The cleaning composition of claim 1, wherein based on the total weight of the cleaning composition, the alkali metal hydroxide has a weight percentage concentration of 5%-30%, the polar aprotic solvent has a weight percentage concentration of 5%-50%, the co-solvent has a weight percentage concentration of 5%-60%, and the remaining is water.

3. The cleaning composition of claim 2, wherein based on the total weight of the cleaning composition, the alkali metal hydroxide has a weight percentage concentration of 10%-25%, the polar aprotic solvent has a weight percentage concentration of 15%-40%, the co-solvent has a weight percentage concentration of 15%-50%, and the remaining is water.

4. The cleaning composition of claim 1, wherein the alkali metal hydroxide comprises at least one selected from the group consisting of lithium hydroxide, sodium hydroxide, potassium hydroxide, rubidium hydroxide, and cesium hydroxide.

5. The cleaning composition of claim 1, wherein the polar aprotic solvent has a relative dielectric constant (Erel) from greater than 15 and up to 180.

6. The cleaning composition of claim 1, wherein the polar aprotic solvent comprises at least one selected from the group consisting of a sulfoxide solvent, a sulfone solvent, an amide solvent, a pyrrolidone solvent, and a lactone solvent.

7. The cleaning composition of claim 6, wherein the sulfoxide solvent comprises at least one selected from the group consisting of dimethyl sulfoxide, diethyl sulfoxide, dipropyl sulfoxide, methyl ethyl sulfoxide, diphenyl sulfoxide, methyl phenyl sulfoxide, and 1,1′-bis(hydroxyphenyl) sulfoxide.

8. The cleaning composition of claim 6, wherein the sulfone solvent comprises at least one selected from the group consisting of sulfolane, 3-methylsulfolane, and 2,4-dimethylsulfolane.

9. The cleaning composition of claim 6, wherein the amide solvent comprises at least one selected from the group consisting of N,N-dimethylformamide, N,N-dimethylacetamide, N,N-dimethylpropanamide, N,N-dimethylbutyramide, N,N-dimethylisobutyramide, N,N-diethylformamide, N,N-diethylacetamide, N,N-diethylpropanamide, N,N-diethylbutyramide, N,N-diethylisobutyramide, N,N-dipropylacetamide, hexamethylphosphamide, N-methylformamide, N-methylacetamide, N-methylpropanamide, N-methyl-N-ethylpropanamide, N-ethyl-N-methylpropanamide, N-ethyl-N-methylbutyramide, N-ethyl-N-methylisobutyramide, formamide, and acetamide.

10. The cleaning composition of claim 6, wherein the pyrrolidone solvent has a C1-C8 alkyl group attached to the N atom thereof.

11. The cleaning composition of claim 6, wherein the pyrrolidone solvent comprises at least one selected from the group consisting of N-methyl-2-pyrrolidone, N-ethylpyrrolidone, N-isopropylpyrrolidone, N-butyl-2-pyrrolidone, N-hydroxyethyl-2-pyrrolidone, and N-hydroxypropyl-pyrrolidone.

12. The cleaning composition of claim 6, wherein the lactone solvent comprises at least one selected from the group consisting of β-propiolactone, γ-butyrolactone, and 8-valerolactone.

13. The cleaning composition of claim 1, wherein the co-solvent comprises an alcohol solvent or an amine solvent.

14. The cleaning composition of claim 13, wherein the co-solvent is a polyol solvent.

15. The cleaning composition of claim 13, wherein the alcohol solvent comprises at least one selected from the group consisting of ethylene glycol, propylene glycol, dipyropylene glycol, glycerol, benzyl alcohol, tetrahydrofurfuryl alcohol, 2-methoxyethanol, phenoxyethanol, and 3-methoxy-3-methylbutanol.

16. The cleaning composition of claim 13, wherein the amine solvent comprises at least one selected from the group consisting of monoethanolamine, triethanolamine, isopropanolamine, 2-(2-aminoethoxy) ethanol, and 2-amino-2-methyl-1-propanol.

17. A removing method of bonding materials, comprising the steps of:
providing the cleaning composition of claim 1;
heating the cleaning composition; and
contacting the cleaning composition with residual polymer film bonding materials on a carrier to remove the polymer film bonding materials.

18. The removing method of claim 17, which is performed by contacting the cleaning composition with the residual polymer film bonding materials on the carrier by utilizing a manner of soaking, dipping, coating, spin-coating, spraying, or rinsing.

19. The removing method of claim 17, wherein the cleaning composition is heated at a temperature ranging from 20° C. to 90° C.
